(19) United States
(12) Patent Application Publication
(10) Pub. No.: US 2018/0225859 A1
(43) Pub. Date: Aug. 9, 2018

(54) SYSTEMS AND METHODS FOR RENDERING CONTENT

(71) Applicant: Facebook, Inc., Menlo Park, CA (US)

(72) Inventor: Martin A. Ortega, Oakland, CA (US)

(21) Appl. No.: 15/426,932

(22) Filed: Feb. 7, 2017

(51) Int. Cl. G06T 13/80; G06T 11/60; G06F 17/24; G06F 17/21

(52) U.S. Cl. CPC G06T 13/80; G06T 11/60; G06F 17/24; G06F 3/04842; G06T 2210/12; G06F 2203/04803; G06T 2200/24; G06F 17/212

(57) ABSTRACT

Systems, methods, and non-transitory computer-readable media can determine at least one content item to be presented through a display screen of the computing device, the content item including a set of sub-content items. A composite web view is created in which each sub-content item in the set of sub-content items is rendered. Each of the sub-content items are replicated in the content item, the sub-content items being replicated from the composite web view.

### FIELD OF THE INVENTION

The present technology relates to the field of content presentation. More particularly, the present technology relates to techniques for rendering content.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

### SUMMARY

Various embodiments of the present disclosure can include systems, methods, and non-transitory computer readable media configured to determine at least one content item to be presented through a display screen of the computing device, the content item including a set of sub-content items. A composite web view is created in which each sub-content item in the set of sub-content items is rendered. Each of the sub-content items are replicated in the content item, the sub-content items being replicated from the composite web view.

In some embodiments, the systems, methods, and non-transitory computer readable media are configured to present the content item through the display screen of the computing device, wherein the content item includes the replicated sub-content items.

In some embodiments, at least one sub-content item corresponds to web content.

In some embodiments, the sub-content items are replicated from the composite web view using keyframe animation techniques.

In some embodiments, an individual keyframe is created for each sub-content item, and wherein a respective animation offset is assigned to each keyframe.

In some embodiments, the keyframes are not interpolated.

In some embodiments, the systems, methods, and non-transitory computer readable media are configured to determine that a user operating the computing device has selected an option associated with a sub-content item included in the content item and map the user selection to a rendered version of the option, wherein the mapping causes one or more operations associated with the option to activate.

In some embodiments, the systems, methods, and non-transitory computer readable media are configured to generate a source bounding box from which the rendered version of the option is accessible and cause a bounding box corresponding to the rendered version of the option to be positioned under a bounding box corresponding to the option included in the content item.

In some embodiments, one or more transformations are applied to position the source bounding box.

In some embodiments, a set of coordinates for the bounding box corresponding to the rendered version of the option in the source bounding box are aligned with a set of coordinates for the bounding box corresponding to the option included in the content item.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content presentation module, according to an embodiment of the present disclosure.

FIG. 2 illustrates an example of a presentation module, according to an embodiment of the present disclosure.

FIG. 3 illustrates an example diagram for replicating sub-content items in a content item, according to an embodiment of the present disclosure.

FIGS. 4A-B illustrate an example diagrams for mirroring components in a content item, according to an embodiment of the present disclosure.

FIG. 5 illustrates an example method, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Rendering Content

People often utilize computing devices (or systems) for a wide variety of purposes. Users can use their computing devices to, for example, interact with one another, access content, share content, and create content. In some cases, content items can include postings from members of a social networking system. The postings may include text and media content items, such as images, videos, and audio. The postings may be published to the social network for consumption by others. Users of the social networking system may interact with other users and/or posts that were published through the social networking system.

Under conventional approaches, content items may be created, or formatted, using various mobile operating systems. For example, content items may be rendered using various operations provided by the iOS operating system. In some instances, such content items may include various sub-content items (e.g., web content such as embeds, photos, videos, etc.) that require one or more web views to be created. A sub-content item, therefore, can be any content that is retrieved from an external source (e.g., content provider) for presentation in a content item. In general, a web view is a component provided by the iOS operating system for use in rendering sub-content items in a content item. Typically, each disparate piece of external content requires its own web view to be created. Thus, a content item that includes many sub-content items (e.g., 20 embeds) will require the same number of web views to accommodate each of the sub-content items. Having an excessive number of web views can significantly degrade the overall operation of a computing device and, therefore, also degrade the user experience. For example, in such instances, users may experience screen stutter. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, a single web view can be created to accommodate all of the different sub-content items that need to be included in a content item to be presented through a computing device. For example, if 30 different embeds from a content provider need to be shown in the content item, a single web view (e.g., a composite web view) that stores (and renders) the 30 embeds can be created. In some embodiments, sub-content items in the composite web view can be individually replicated and positioned at their corresponding locations in the content item. The content item can seamlessly be presented on a computing device along with any sub-content items as if the sub-content items were rendered using individually created web views.

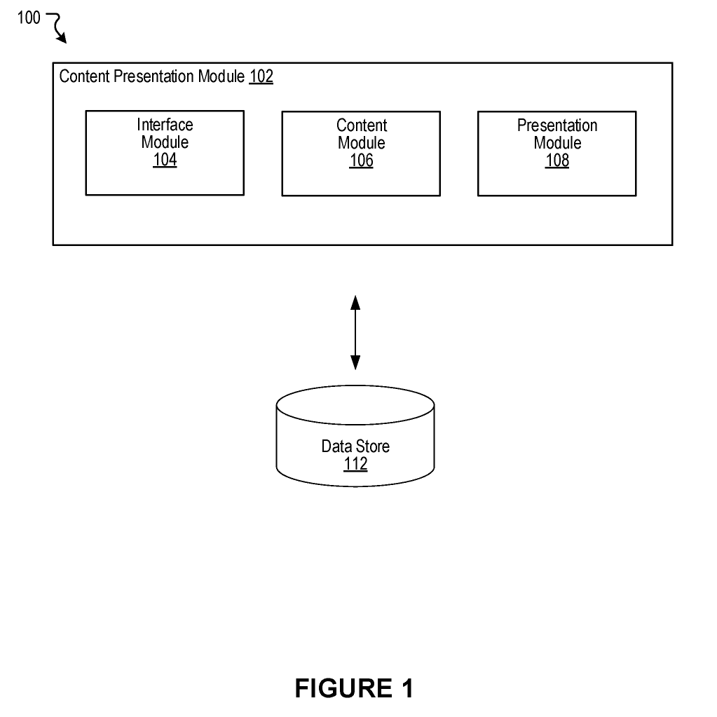

FIG. 1 illustrates an example system 100 including an example content presentation module 102, according to an embodiment of the present disclosure. As shown in the example of FIG. 1, the content presentation module 102 can include an interface module 104, a content module 106, and a presentation module 108. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

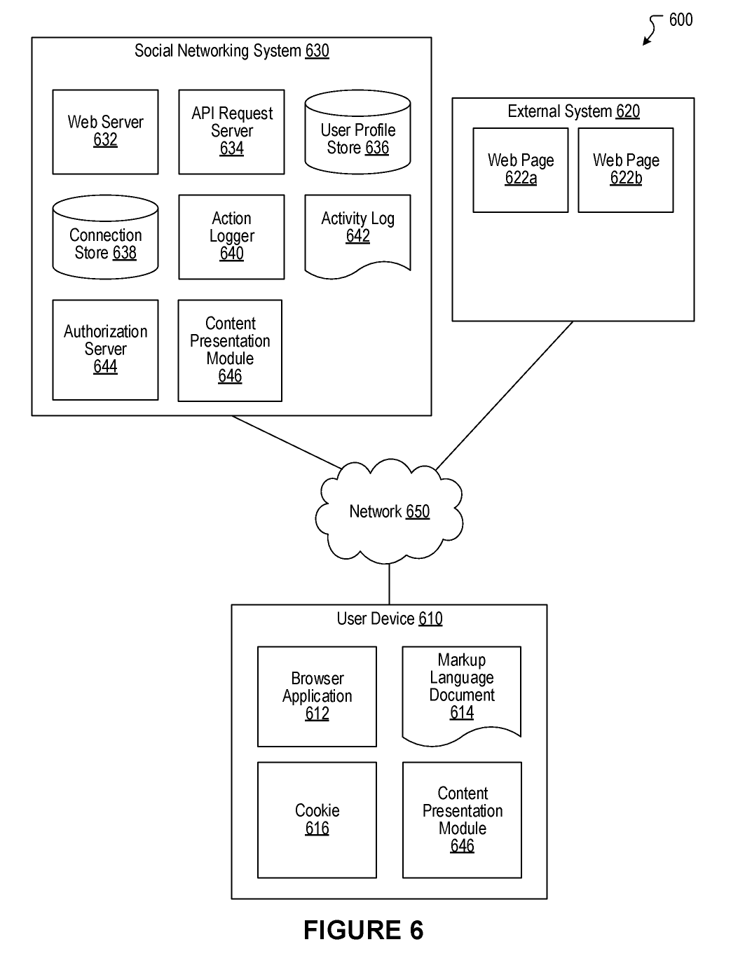

In some embodiments, the content presentation module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the content presentation module 102 can be implemented, in part or in whole, as software running on one or more computing devices or systems, such as on a user computing device or client computing system. For example, the content presentation module 102, or at least a portion thereof, can be implemented as or within an application (e.g., app), a program, or an applet, etc., running on a user computing device or a client computing system, such as the user device 610 of FIG. 6. Further, the content presentation module 102, or at least a portion thereof, can be implemented using one or more computing devices or systems that include one or more servers, such as network servers or cloud servers. In some instances, the content presentation module 102 can, in part or in whole, be implemented within or configured to operate in conjunction with a social networking system (or service), such as the social networking system 630 of FIG. 6. It should be understood that there can be many variations or other possibilities.

In some embodiments, the content presentation module 102 can be configured to communicate and/or operate with the at least one data store 112 in the example system 100. The at least one data store 112 can be configured to store and maintain various types of data. In various embodiments, the at least one data store 112 can store data relevant to the function and operation of the content presentation module 102. One example of such data includes data corresponding to content items that are available to be presented by the interface module 104. In some implementations, the at least one data store 112 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 112 can store information associated with users, such as user identifiers, user information, profile information, user specified settings, content produced or posted by users, and various other types of user data. It should be appreciated that there can be many variations or other possibilities.

In various embodiments, the content presentation module 102 can utilize the interface module 104 and the content module 106 to provide content items to users. The interface module 104 can be configured to provide an interface (e.g., graphical user interface) through which content items can be presented and accessed. For example, the interface can be provided through a software application (e.g., a social networking application, browser, etc.) running on a computing device (e.g., the user device 610 of FIG. 6) being operated by a user. The user can interact with the interface, for example, by performing touch screen gestures through a display screen of the computing device.

The content module 106 can be configured to provide various types of content items that can be presented to users through the interface provided by the interface module 104. For example, the content module 106 can interact with a content provider system, such as the social networking system 630 of FIG. 6, to obtain various content items to be presented through the interface module 104. The content items can be presented through a display screen of the computing device, for example, as part of a content feed (e.g., news feed). Users can navigate (e.g., browse) the content feed through a display screen of the computing device to access the different content items that are available in the content feed. In some embodiments, the user can navigate the content feed by performing a scroll gesture to move up or down the content feed.

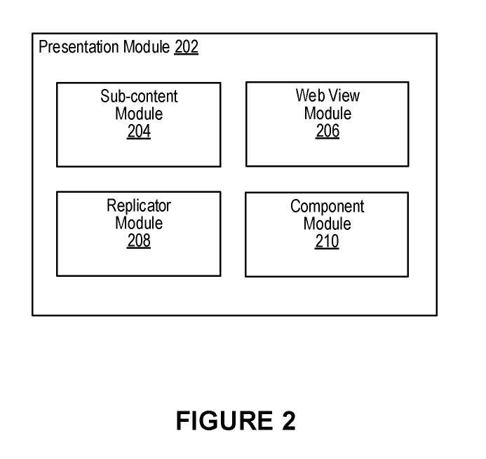

In various embodiments, the presentation module 108 can be configured to prepare content items for presentation. For example, in some embodiments, the presentation module 108 can identify sub-content items (e.g., external web content, embeds, images, videos, etc.) included in a content item to be presented. In some embodiments, the presentation module 108 can create a composite web view for rendering the various sub-content items to be included in the content item. When presenting the content item through a computing device, the presentation module 108 can automatically replicate the sub-content items from the composite web view and present the replicated sub-content items in their corresponding locations in the content item. More details regarding the presentation module 108 will be provided below in reference to FIG. 2.

FIG. 2 illustrates an example presentation module 202, according to an embodiment of the present disclosure. In some embodiments, the presentation module 108 of FIG. 1 can be implemented with the presentation module 202. As shown in the example of FIG. 2, the presentation module 202 can include a sub-content module 204, a web view module 206, a replicator module 208, and a component module 210.

In some embodiments, the sub-content module 204 can be configured to identify any sub-content items to be shown when presenting a given content item. In general, a sub-content item can correspond to any web content that is obtained from one or more external computing systems. Web content can include embedded content (or embeds), images, videos, and audio, to name some examples.

In some embodiments, the web view module 206 can create web views for rendering the various sub-content items to be included in the content item. In general, a web view is a component provided by the iOS operating system for use in rendering sub-content items in a content item. Conventionally, a separate web view is created for each sub-content item to be rendered in a content item. Such conventional usage of web views can degrade the user experience for the reasons described above. Thus, in some embodiments, the web view module 206 is configured to create a composite web view for the content item to be presented. The sub-content items to be shown when presenting the content item can separately be rendered in the composite web view. In some embodiments, all sub-content items in the content item are rendered in the same composite web view.

In some embodiments, the replicator module 208 can be configured to replicate (or extract) sub-content items that were rendered in the composite web view for presentation within the content item. In some embodiments, the replicator module 208 is configured to replicate content using a replication layer (e.g., CAReplicatorLayer) provided by the iOS operating system. For example, the replicator module 208 can attach a replication layer to the composite web view that was created for the content item to be presented. In this example, each sub-content item included in the composite web view can then be replicated in the content item to be presented. That is, the replicator module 208 can instruct the replication layer to draw each sub-content item at its corresponding position in the content item.

In various embodiments, the replicator module 208 can apply keyframe animation techniques to replicate sub-content items. Such keyframe animations can be created using functionality provided by the iOS operating system (e.g., CAReplicatorLayer, CAPropertyAnimation, CABasicAnimation, CAKeyframeAnimation, etc.). For example, when replicating a first sub-content item from the composite web view, the replicator module 208 can specify a position (e.g., coordinates) in the content item at which a keyframe corresponding to the first sub-content item should be drawn (or animated). The replicator module 208 can also specify that no interpolation be performed for the keyframe (or no interpolation be performed for the keyframe until some threshold amount of time has elapsed). The replicator module 208 can animate the keyframe so that only the portion of the composite web view that corresponds to the first sub-content item is animated while cropping (or clipping) the remaining portions of the composite web view. The portion corresponding to the first sub-content item may be determined based the coordinates of the first sub-content item (e.g., coordinates corresponding to the top-left corner of the item) in the composite web view and dimensions (e.g., weight and height) corresponding to the first sub-content item. In some embodiments, such coordinates are determined using a coordinate system provided by the iOS operating system.

Naturally, there may be multiple sub-content items that need to be included in the content item. To allow for multiple sub-content items to be included, the keyframing process described above can be repeated for other sub-content items to be included in the content item. When animating multiple sub-content items, in some embodiments, the replicator module 208 can specify different animation offsets for each of the keyframes corresponding to the replicated sub-content items. For example, the animation offset for a first keyframe corresponding to the first sub-content item can be specified as T0 while the animation offset for a second keyframe corresponding to a second sub-content item can be specified as T1. In some embodiments, the time difference between T0 and T1 (and any subsequent animation offsets) can be defined as some large threshold amount of time (e.g., 30 days, 1 year, etc.). To ensure that sub-content items are all shown (or animated), in some embodiments, the replicator module 208 activates each keyframe at the same time. For example, the replicator module 208 can specify a time property (e.g., using CAMediaTiming) for the first keyframe so that the first keyframe interprets the time to be TO when the content item is presented. Similarly, the replicator module 208 can specify a time property for the second keyframe so that the second keyframe interprets the time to be T1 when the content item is presented. This can be done for all keyframes corresponding to replicated sub-content items. As a result, each keyframe corresponding to a replicated sub-content item is animated at the same time when the content item is presented regardless of the actual animation offsets defined for the keyframe. Moreover, since the time difference between the respective animation offsets for the keyframes is defined as a large threshold amount of time, the risk of having the animation for the first keyframe (starting at T0) reach the animation offset for the second keyframe (starting at T1) is reduced or eliminated.

In some embodiments, the component module 210 can be configured to activate options (e.g., UI components such as buttons, scroll bars, etc.) included in sub-content items for which user feedback (e.g., touch gestures) was received. As mentioned, sub-content items can be replicated in a content item from a composite web view. In some instances, sub-content items may include various options (e.g., a share option, reply option, etc.). Since sub-content items are replicated from a composite web view, any user selections received for options included in the sub-content items need to be mirrored back to the appropriate locations in the composite web view to allow the selected options to be performed.

In some embodiments, the component module 210 enables such mirroring by determining a coordinate system for the display screen of the computing device on which the content item is to be presented. In general, the composite web view for the content item can exist within this same coordinate system and usually at some location not visible on the display screen. In some embodiments, the component module 210 may rely on the coordinate system provided by the iOS operating system. The component module 210 can also determine respective bounding boxes for each of the options corresponding to sub-content items replicated in the content item. In one example, the component module 210 can define a bounding box for an option based on a set of coordinates (e.g., first coordinates for top-left corner, second coordinates for top-right corner, third coordinates for bottom-left corner, and fourth coordinates for bottom-right corner). When a user selects (e.g., touch gesture) an option (“visual option”) drawn in the content item, the component module 210 can determine the coordinates corresponding to the user's selection (e.g., touch gesture). In this example, the visual option is determined to be selected when the coordinates of the user selection correspond to a location that is encompassed by a bounding box determined for the visual option. This user selection then needs to be mapped to a location corresponding to a corresponding option (“real option”) rendered in the composite web view. In some embodiments, such mapping is performed using a source bounding box that includes all of the real options corresponding to sub-content items rendered in the composite web view. In such embodiments, a respective bounding box is also determined for each real option in the source bounding box.

For example, when a user selects a visual option drawn in the content item, the component module 210 can determine that the selection is being made and also the bounding box coordinates (e.g., the top-left coordinates) for the visual option being selected. The component module 210 can also determine the bounding box coordinates (e.g., top-left coordinates) for the corresponding real option included in the source bounding box. Next, the component module 210 can apply various transformations to the source bounding box so that the bounding box coordinates for the real option in the source bounding box match the bounding box coordinates for the visual option selected through the display screen. Such matching of bounding box coordinates for the selected visual option and the corresponding real option causes any actions associated with the real option to be triggered (or activated). This process is repeated as additional visual options are selected by the user. As a result, the component module 210 can continue applying such transformations to the source bounding box as subsequent options are selected.

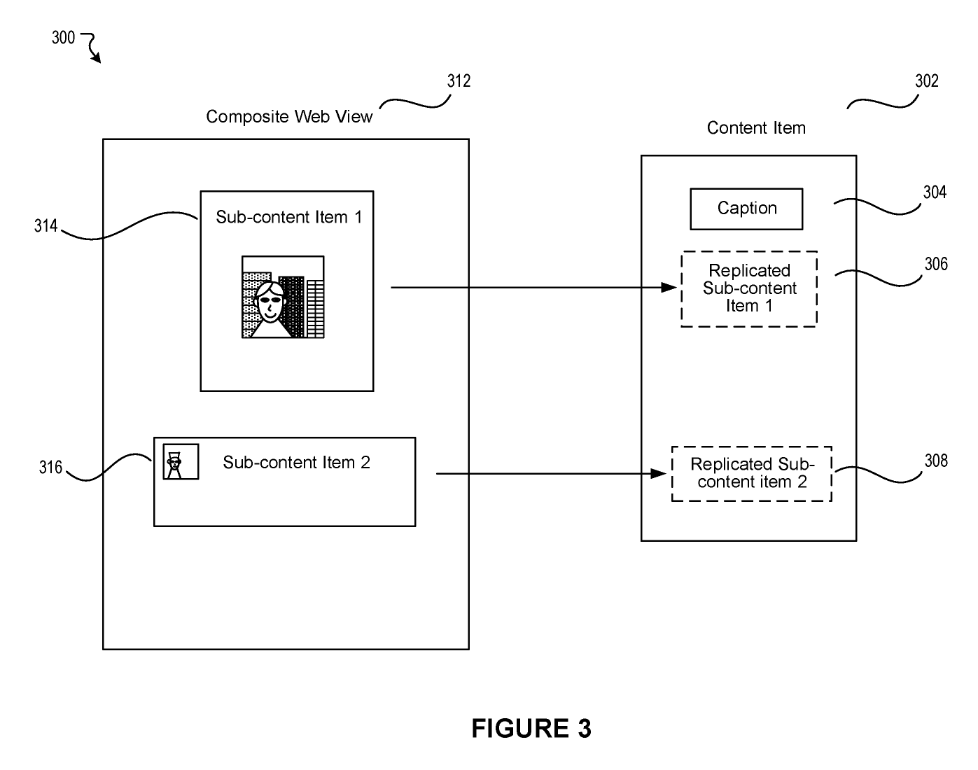

FIG. 3 illustrates an example diagram 300 for replicating sub-content items in a content item, according to an embodiment of the present disclosure. FIG. 3 illustrates a content item 302 to be presented on a display screen of a computing device. The content item 302 includes a caption 304 provided by a publisher of the content item. The content item 302 also includes a first sub-content item 306 and a second sub-content item 308. As mentioned, in some embodiments, a composite web view 312 can be created to render sub-content items to be presented in the content item 302. In the example of FIG. 3, the composite web view 312 includes renderings of the first sub-content item 314 and the second sub-content item 316. In various embodiments, the first sub-content item 314 and the second sub-content item 316 can be replicated from the composite web view 312 for inclusion in the content item 302 when the content item 302 is presented. In some embodiments, the first sub-content item 314 and the second sub-content item 316 can be replicated using the keyframe animation techniques described above.

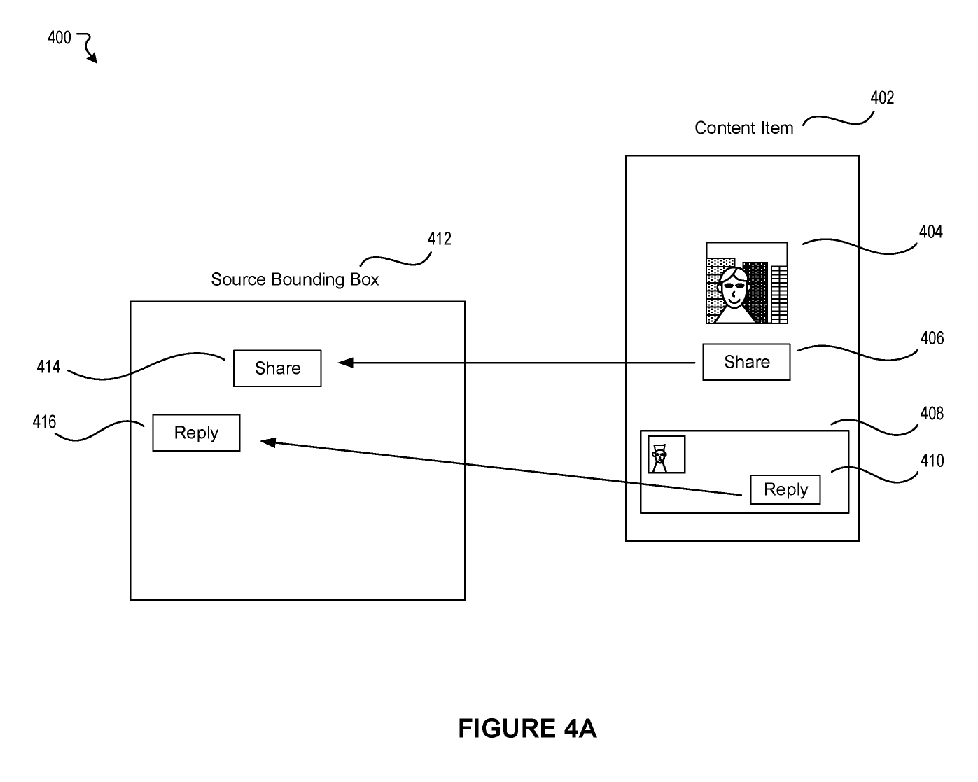

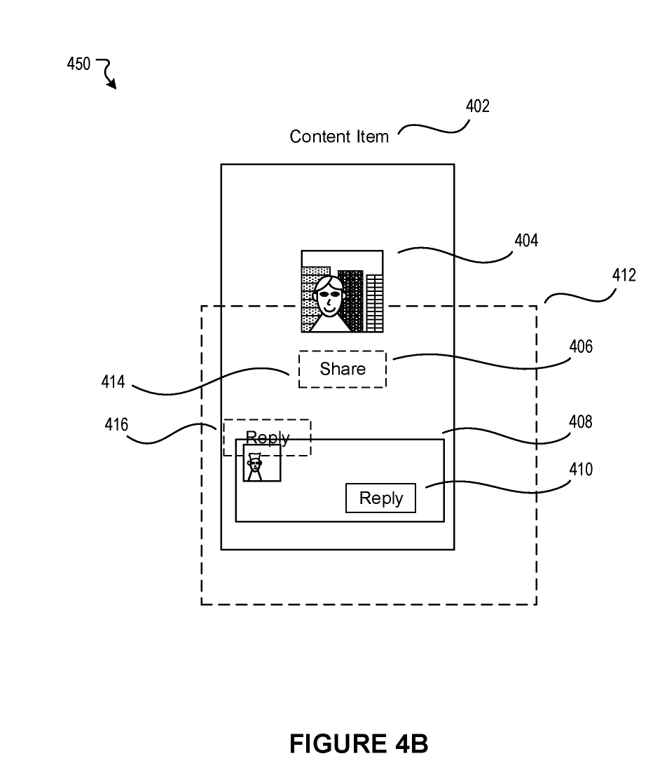

FIG. 4A illustrates an example diagram 400 for mirroring components in a content item, according to an embodiment of the present disclosure. FIG. 4A illustrates a content item 402 to be presented on a display screen of a computing device. The content item 402 includes a first sub-content item 404 and a visual option 406 associated with the first sub-content item 404. The content item 402 also includes a second sub-content item 408 and a visual option 410 associated with the second sub-content item 408. As mentioned, sub-content items can be replicated in the content item 402 from a composite web view. Since sub-content items are replicated from a composite web view, any user selections received for options included in the sub-content items need to be mirrored back to the appropriate locations in the composite web view to allow the selected option to be activated. For example, any user selections of the visual option 406 would need to be mirrored (or mapped) back to a corresponding real option rendered in the composite web view. In some embodiments, such mapping is performed using a source bounding box 412 that contains all of the options corresponding to the sub-content items rendered in the composite web view. In this example, the source bounding box 412 includes a real option 414 that corresponds to the visual option 406 and a real option 416 that corresponds to the visual option 410. In such embodiments, respective bounding boxes are determined for each real option in the source bounding box (e.g., real option 414 and option real 416) and also each visual option replicated in the content item 402 (e.g., visual option 406 and visual option 410).

When a user selects a visual option replicated in the content item 402 (e.g., the visual option 406), the bounding box coordinates (e.g., the top-left coordinates) for the selected visual option 406 are determined. Similarly, the bounding box coordinates (e.g., top-left coordinates) for the corresponding real option 414 included in the source bounding box 412 are also determined. One or more transformations are applied to the source bounding box 412 so that the bounding box coordinates for the real option 414 in the source bounding box 412 correspond (or match) the bounding box coordinates for the visual option 406 selected through the display screen, as illustrated in the example of FIG. 4B. Such matching of bounding box coordinates allows for any actions associated with the real option 414 to be triggered (or activated).

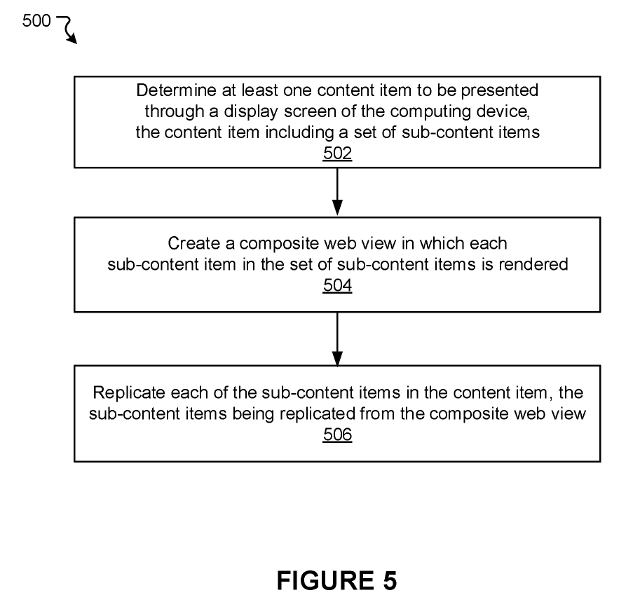

FIG. 5 illustrates an example method 500 for determining a content item layout, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can determine at least one content item to be presented through a display screen of the computing device, the content item including a set of sub-content items. At block 504, a composite web view is created in which each sub-content item in the set of sub-content items is rendered. At block 506, each of the sub-content items are replicated in the content item, the sub-content items being replicated from the composite web view.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the user device 610 and/or the social networking system 630 can include a content presentation module 646. The content presentation module 646 can, for example, be implemented as the content presentation module 102 of FIG. 1. As discussed previously, it should be appreciated that there can be many variations or other possibilities.

### Hardware Implementation

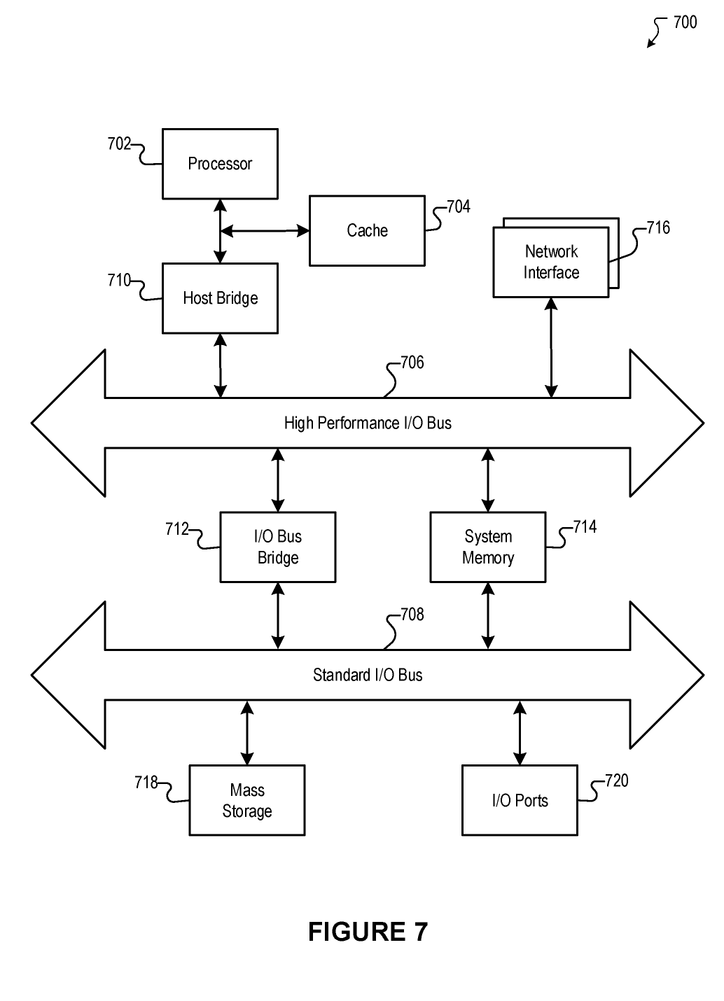

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing device, at least one content item to be presented through a display screen of the computing device, the content item including a set of sub-content items;
creating, by the computing device, a composite web view in which each sub-content item in the set of sub-content items is rendered; and
replicating, by the computing device, each of the sub-content items in the content item, the sub-content items being replicated from the composite web view, wherein the sub-content items are replicated from the composite web view using keyframe animation techniques.

2. The computer-implemented method of claim 1, the method further comprising:
presenting, by the computing device, the content item through the display screen of the computing device, wherein the content item includes the replicated sub-content items.

3. The computer-implemented method of claim 1, wherein at least one sub-content item corresponds to web content.

4. (canceled)

5. The computer-implemented method of claim 4, wherein an individual keyframe is created for each sub-content item, and wherein a respective animation offset is assigned to each keyframe.

6. The computer-implemented method of claim 5, wherein the keyframes are not interpolated.

7. The computer-implemented method of claim 1, the method further comprising:
determining, by the computing device, that a user operating the computing device has selected an option associated with a sub-content item included in the content item; and
mapping, by the computing device, the user selection to a rendered version of the option, wherein the mapping causes one or more operations associated with the option to activate.

8. The computer-implemented method of claim 7, wherein mapping the user selection to the rendered version of the option further comprises:
generating, by the computing device, a source bounding box from which the rendered version of the option is accessible; and
causing, by the computing device, a bounding box corresponding to the rendered version of the option to be positioned under a bounding box corresponding to the option included in the content item.

9. The computer-implemented method of claim 8, wherein one or more transformations are applied to position the source bounding box.

10. The computer-implemented method of claim 8, wherein a set of coordinates for the bounding box corresponding to the rendered version of the option in the source bounding box are aligned with a set of coordinates for the bounding box corresponding to the option included in the content item.

11. A system comprising:
at least one processor; and
a memory storing instructions that, when executed by the at least one processor, cause the system to perform:
determining at least one content item to be presented through a display screen of the computing device, the content item including a set of sub-content items;
creating a composite web view in which each sub-content item in the set of sub-content items is rendered; and
replicating each of the sub-content items in the content item, the sub-content items being replicated from the composite web view, wherein the sub-content items are replicated from the composite web view using keyframe animation techniques.

12. The system of claim 11, wherein the instructions further cause the system to perform:
presenting the content item through the display screen of the computing device, wherein the content item includes the replicated sub-content items.

13. The system of claim 11, wherein at least one sub-content item corresponds to web content.

14. (canceled)

15. The system of claim 14, wherein an individual keyframe is created for each sub-content item, and wherein a respective animation offset is assigned to each keyframe.

16. A non-transitory computer-readable storage medium including instructions that, when executed by at least one processor of a computing system, cause the computing system to perform a method comprising:
determining at least one content item to be presented through a display screen of the computing device, the content item including a set of sub-content items;
creating a composite web view in which each sub-content item in the set of sub-content items is rendered; and
replicating each of the sub-content items in the content item, the sub-content items being replicated from the composite web view, wherein the sub-content items are replicated from the composite web view using keyframe animation techniques.

17. The non-transitory computer-readable storage medium of claim 16, wherein the instructions further cause the computing system to perform:
presenting the content item through the display screen of the computing device, wherein the content item includes the replicated sub-content items.

18. The non-transitory computer-readable storage medium of claim 16, wherein at least one sub-content item corresponds to web content.

19. (canceled)

20. The non-transitory computer-readable storage medium of claim 19, wherein an individual keyframe is created for each sub-content item, and wherein a respective animation offset is assigned to each keyframe.
